(19) United States
(12) Patent Application Publication
(10) Pub. No.: US 2014/0305790 A1
(43) Pub. Date: Oct. 16, 2014

(54) PROCESS FOR TREATING EFFLUENTS IN A BED OF MICROBEADS BY COLD PLASMA AND PHOTOCATALYSIS

(71) Applicants: Pierre-Alexandre Deveau, Peyrus (FR); Didier Parzy, Mornant (FR)

(72) Inventors: Pierre-Alexandre Deveau, Peyrus (FR); Didier Parzy, Mornant (FR)

(21) Appl. No.: 14/361,817

(22) PCT Filed: Nov. 26, 2012
(86) PCT No.: PCT/FR2012/052718

§ 371 Date: May 30, 2014

(30) Foreign Application Priority Data
Dec. 1, 2011 (FR) 1161056

(51) Int. Cl. B01J 19/12

(52) U.S. Cl. CPC B01J 19/123; B01J 2219/1203
USPC 204/157.15; 422/186.3

(57) ABSTRACT

The invention relates to a process for treating effluents (2) moving between the inlet (4) and outlet (5) of a reactor (1), the process consisting in treating the effluents by means of a cold plasma treatment and by means of a UV-photocatalytic agent in order to produce oxidizing species for treating the effluents.

In accordance with the invention, the process consists in treating the effluents with a cold plasma treatment simultaneously with the action of a UV-photocatalytic agent, the cold plasma treatment being carried out in a manner that is integrated into and located within a bed of porous microbeads (9) placed inside the reactor (1) and carrying the photocatalytic agent in order to generate oxidizing species as well as to diffuse them within the bed.

The present invention relates to treating gaseous or aqueous effluents containing chemical pollutants, microorganisms, and/or particles, using the combined photocatalysis and cold plasma techniques.

The aim of the present invention is to treat effluents containing environmental pollutants such as, for example, particles, microorganisms of the virus, bacteria, mold and algae type and chemical pollutants of the VOC, SVOC, BTEX, HAP (C10-C25), HAAA, NOₓ, SOₓ, H₂S, CO, or O₃ type, halogenated compounds, endocrine disruptors and all olfactive molecules.

The subject matter of the invention is of particularly advantageous but not exclusive application, for example, in chemical and petrochemical industrial fields, medical and hospital fields, agroalimentary formulation lines, food production and farming sites of the poultry, horticultural, arboricultural, and viticultural types, cold storage of perishable foodstuffs of the fruit, vegetable, fish, meat, cheese, or bakery type, water treatment plants, micro-stations, rainwater collection tanks, in tertiary, private and communal sectors serving the public and in dwellings, etc.

The principle of a cold plasma generated by a dielectric barrier discharge is to form excited radical type chemical species, anions and cations. Generating a gaseous plasma in this manner means that the chemical bonds of pollutants contained in a gaseous or aqueous effluent can be attacked. In practice, a cold plasma is obtained at atmospheric pressure by applying a high voltage between two symmetrical electrodes separated by a dielectric such as an air gap. Under the effect of an electric arc, the air gap is ionized. The electric arc ionizes the components contained in the environment and forms anions, cations, minor radicals, and excited species. Those compounds degrade the chemical compounds that are present.

Using the cold plasma generated by a dielectric barrier discharge to destroy chemical molecules and volatile organic compounds (VOC) is known in the art. In that technique, forming a plasma in an effluent containing oxygen at atmospheric pressure means that O₃ can be generated. Depending on its concentration, O₃ has a germicidal effect on the microorganisms.

Photocatalysis is a chemical oxidation-reduction process employing a photocatalytic agent that is capable of destroying the various organic pollutants present in air or water, by a reaction provoked by excitation with ultraviolet (UV) photons. The photocatalysis provides for the formation of radicals (O₂ and OH) following UV irradiation of a metal oxide (M—OX) type semiconductor at a wavelength shorter than 380 nanometers (nm). During UV irradiation, the electron cloud of an M—OX type semiconductor is modified; one or more electrons cross the electron gap. In contact with air and water, these electrons form radicals of the hydroxyl and oxygen type on the surface of the M—OX type semiconductor. These radicals, which have very high reaction kinetics, attack the organic chemical components adsorbed on the active M—OX sites by the UV radiation and degrade them, breaking their chemical bonds. Total or partial degradation of the compounds may thus occur, into CO₂, H₂O, N₂, etc.

The use of UV photocatalysis alone in order to degrade chemical compounds contained in gaseous effluents has been described, for example, in patent application WO 00/72945. Further, the two techniques, photocatalysis and cold plasma, have already been described in combination.

As an example, patent application WO 2007/051912 describes a process for treating gaseous effluents that simultaneously couples cold plasma from a dielectric barrier discharge and photocatalysis with an external UV source in a trickle bed type reactor. The walls of the dielectric of the dielectric barrier discharge device are coated with TiO₂ as the photocatalytic agent. The plasma discharge occurs within a photocatalyst activated by UV irradiation. The technique described in that document suffers from the disadvantage that the reactive species created during the discharge in the TiO₂ are predominantly anions and cations, a fraction of which is consumed to generate radicals from O₂⁻, O₃⁻ and OH⁻. That technique limits the formation of ozone during the discharge, but does not prevent its formation at the reactor outlet as well as the formation of secondary pollutants. Furthermore, the geometry of the reactor means that it is not possible to obtain sufficiently long mineralization times to turn all of the ionic species produced by the discharge into radicals.

Patent US 2002/0168305 also describes a system for treating air in order to decontaminate virus and bacteria type microorganisms. That treatment system comprises an annular reactor at the center of which a discharge lamp is placed in order to ionize the air and form ozone. A porous dielectric included between two metal mesh sleeves makes up the walls of the reactor. A dielectric discharge is produced in that portion to allow ionic and radical species to form and also to consume ozone formed in the central chamber.

The purification is carried out in three steps:
UV irradiation and ionization in the core of the reactor, with the generation of ionic species and ozone;
electric discharge and photocatalysis within a porous dielectric: formation of ions and ozone, and the formation of radicals and destruction of ozone throughout the porous dielectric;
filtration at the outlet.

That technique suffers from the same disadvantages as in patent application WO 2007/051912. The photocatalytic reaction gives rise to homolytic redox reactions generating radicals, while the electric discharge process gives rise to heterolytic reactions with ions. In addition, the photocatalysis reaction is more rapid and thus predominant, which limits the formation of a heterogeneous gradient of the ion, ozone and radical reactive species inside the reactor. The oxidizing capacity does not change and cannot effectively and completely mineralize the chemical pollutants and microorganic contaminants.

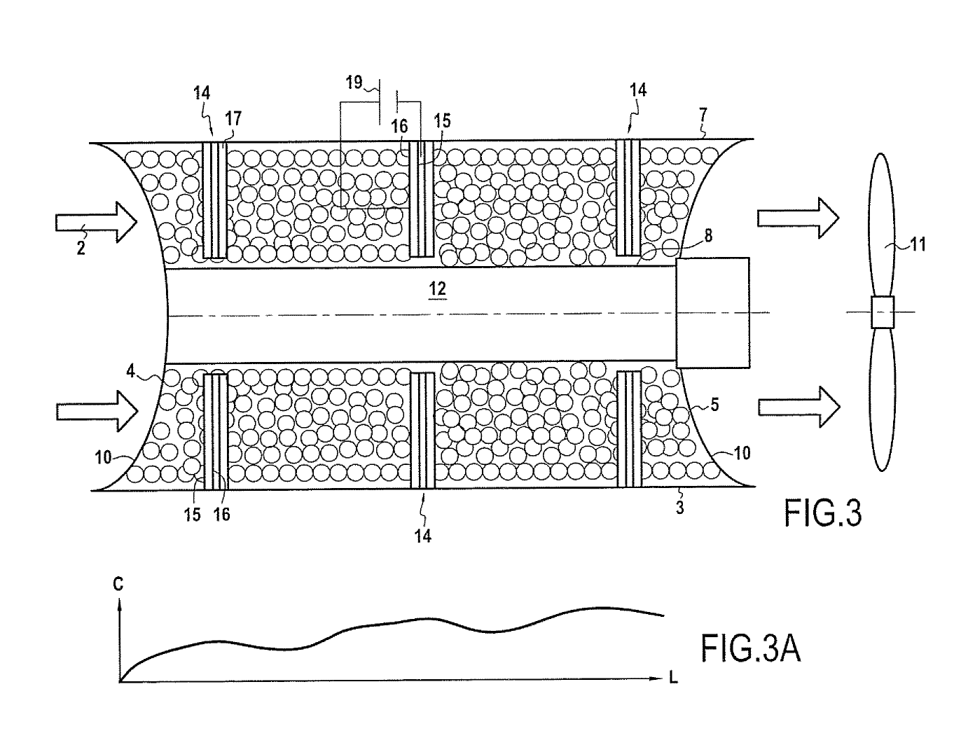

The publication by J. Y. BAN et al, “Highly concentrated toluene decomposition on the dielectric barrier discharge (DBD) plasma-photocatalytic hybrid system with Mn—Ti-incorporated mesoporous silicate photocatalyst (MN—Ti-MPS)”, Applied Surface Science, ELSEVIER, AMSTERDAM, NL, vol. 253, No. 2, Nov. 15, 2006 (2006-Sep.-15), pp 535-542, SP024893621, ISSN: 0169-4332, DOI: 10.1016/J. APSUSC. 2005.12.103 [extract of Nov. 15, 2006]*chapter 2.4 “Analysis of product for toluene decomposition”; page 537-page 538; FIG. 3 describes a study of the use of a mesoporous silicate compound incorporating Mn and Ti for the destruction of toluene in a hybrid system based on plasma treatment and photocatalysis. To this end, the reactor described comprises a plasma reactor followed in series by a photocatalytic reactor containing a photocatalytic agent. The toluene is degraded by passing toluene initially through the plasma reactor that acts via the discharge to pre-degrade the toluene with the aid of the formation of ionic species, and then to mineralize the by-products from the photocatalytic reactor to CO₂.

That technique is applied exclusively to the destruction of toluene by carrying out pre-degradation by ionization followed by mineralization, which limits the applications of such a technique. Furthermore, that technique cannot be used to obtain treatment that is efficient, since the technology degrades the pollutants in two successive reactions:
addition and substitution reactions of the ionic species generated, forming intermediate secondary reaction products that might be more toxic than the initial pollutants;
followed by photocatalytic oxidations, in which the performance depends on the oxidizing capacity determined by the set-up of the photocatalytic reactor, which cannot be used to obtain optimized toluene mineralization.

The secondary intermediate products formed after the first plasma reactor compete with the toluene during their radical degradation in the second photocatalytic reactor. Toxic species that will not be reduced are necessarily present, as can be seen in FIGS. 10 and 11, which demonstrate the limits of such a technique, obtaining CO₂ conversions of 27% to 43.87% and the appearance of toxic secondary reaction intermediates including benzene, which is mutagenic, carcinogenic, and toxic (CMR).

Furthermore, it should be noted that the toluene mineralization tests were carried out by injecting 1000 ppm of toluene, which means that such a system cannot be used for industrial applications necessitating the continuous treatment of gaseous effluents.

Thus, the present invention is aimed at overcoming the disadvantages of the prior art by proposing a technique for treating effluents by simultaneously combining photocatalysis by UV irradiation with the production of cold plasma, this technique being suitable for controlling the oxidizing species produced in order to improve the organic compound destruction performances in effluents of any origin.

Thus, the present invention proposes a process for treating effluents moving between the inlet and outlet of a reactor, consisting in treating the effluents by means of a cold plasma treatment and by means of the action of a UV-photocatalytic agent in order to produce oxidizing species for treating the effluents.

According to the invention, the process consists in carrying out the cold plasma treatment in a manner that is integrated into and located within a bed of porous microbeads placed inside the reactor and carrying the photocatalytic agent in order to generate oxidizing species as well as to diffuse them within the bed.

In addition, the process of the invention may also present at least one and/or more of the following additional features in combination:
producing a fluidized bed of porous microbeads within the reactor;
carrying out at least one cycle of treatment on the effluents in succession between the inlet and outlet of the reactor, the treatment cycle comprising a photocatalytic treatment and partial absorption by the porous microbeads, a photocatalytic treatment combined with a cold plasma treatment and partial absorption by the porous microbeads, and a photocatalytic treatment and partial absorption by the porous microbeads.

A further aim of the invention is to provide a reactor for carrying out the treatment process.

In accordance with the invention, the reactor comprises:
a vessel defining a circuit for moving the effluents between an inlet and an outlet and within which a bed of porous microbeads carrying a UV-photocatalytic agent is installed;
at least one source of UV irradiation for the porous microbeads; and
at least one dielectric barrier discharge device generating cold plasma, integrated into the bed of porous microbeads in a localized manner so as to generate oxidizing species as well as diffuse them within the bed.

In addition, the reactor of the invention may also present, in combination, at least one and/or another of the following additional features:
the vessel is defined by mutually concentric outer and inner walls, the source of UV irradiation being mounted in the housing defined by the inner wall, while a series of dielectric barrier discharge devices are integrated into the interior of the vessel;
the dielectric barrier discharge devices are disposed either axially, being distributed angularly in the vessel, or radially from the inner wall in one or more cross sections of flow of the vessel;
the vessel is defined by an elongate box having the inlet for the effluents on one of its faces and the outlet for the effluents on the opposite face, which outlet is offset laterally relative to the inlet, the box containing the bed of porous microbeads in which the dielectric barrier discharge device and the source of UV irradiation are accommodated;
the vessel is defined by an outer peripheral wall defining the inlet and connected to two transverse walls, one of which defines the outlet;
the vessel comprises a series of treatment modules in a staggered arrangement inside the vessel, each comprising a steerable support supporting the sources of UV irradiation and the dielectric barrier discharge devices;
the vessel is produced in the form of a cartridge that can be detached, comprising a mounting base provided with temporary fastener means and electrical connection terminals for the dielectric barrier discharge device and the source of UV irradiation, the bed of porous microbeads being retained on the base with the aid of a retaining screen that is permeable to the effluents to be treated;
a system for fluidizing the bed of porous microbeads;
the system for fluidizing the bed of porous microbeads allows for over-pressurization or under-pressurization of the bed of porous microbeads;
the porous microbeads have pore sizes in the range 3 Angstroms (Å) to 10 Å;
the porous microbeads have a diameter in the range 500 micrometers (μm) to 5 centimeters (cm), preferably in the range 1000 μm to 8000 μm;
the porous microbeads are formed from ilmenite, zeolite, activated coal, and/or potassium permanganate;
the photocatalytic agent of the porous microbeads is taken from the following list, alone or in combination: ilmenite, TiO₂, ZnO, MO, and heavy metals;
the source of UV irradiation emits at a wavelength in the range 150 nm to 420 nm; and
the source of UV irradiation is formed by a series of UV diodes distributed at the periphery of the retaining screen.

Various other features become apparent from the description below made with reference to the accompanying drawings that show embodiments of the subject matter of the invention by way of non-limiting examples.

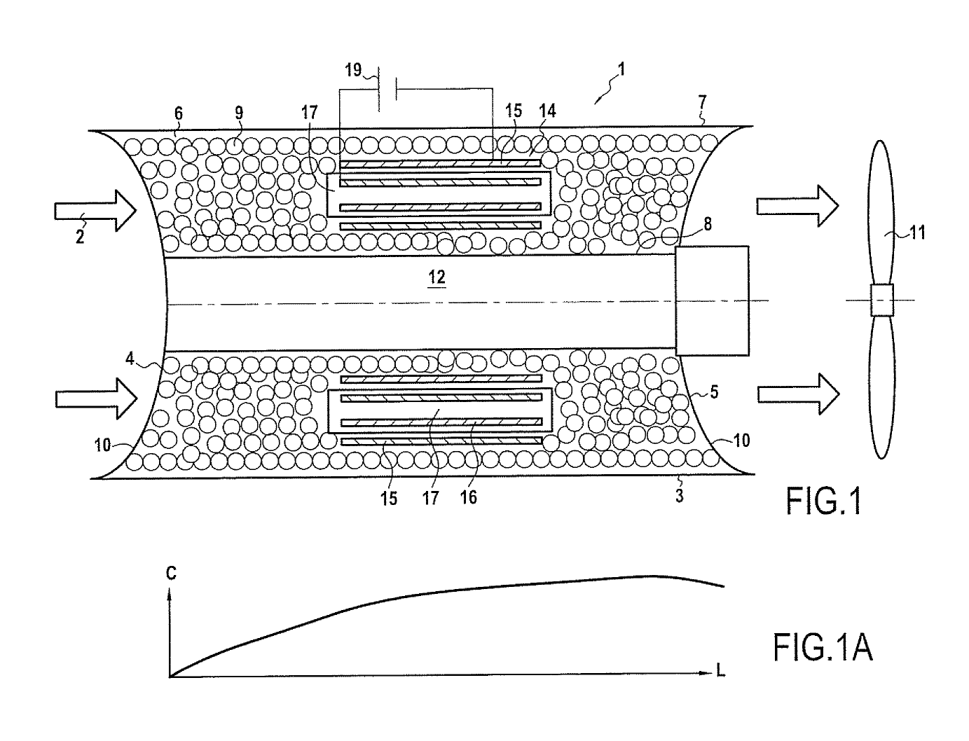

FIG. 1 is a longitudinal sectional view of a first exemplary embodiment of a treatment reactor in accordance with the invention.

FIG. 1A is a diagram showing the variation in the oxidizing capacity C obtained inside the reactor as a function of the path L of the effluents.

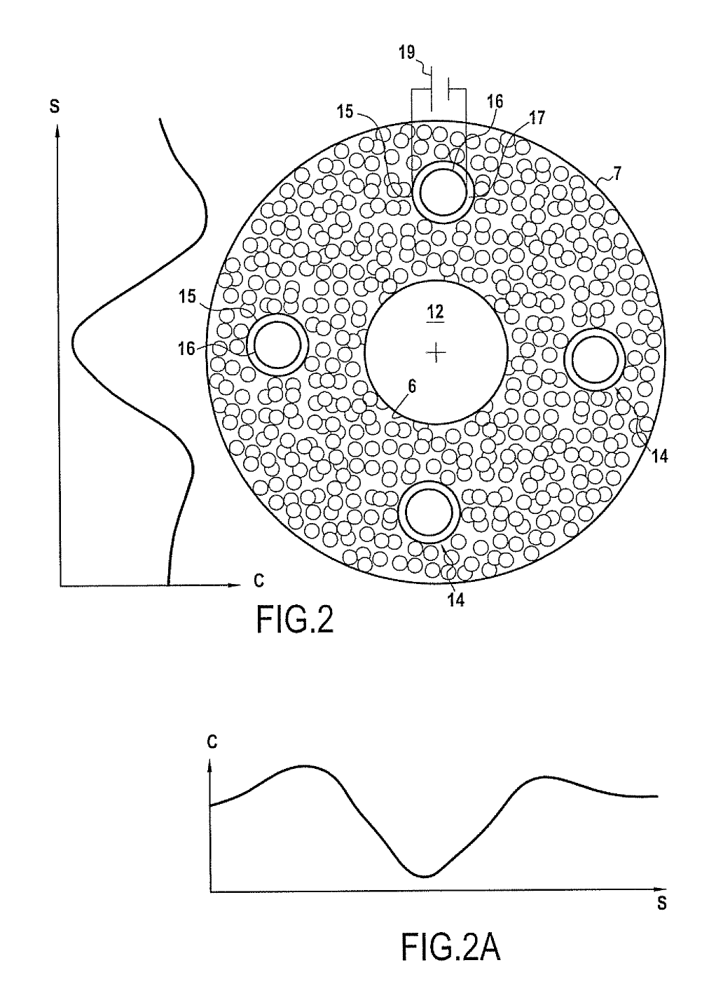

FIG. 2 is a transverse sectional view taken substantially along the lines II-II of FIG. 1 of the reactor in accordance with the invention.

FIG. 2A is a view showing the variation in the oxidizing capacity C obtained inside the reactor along a cross section S of said reactor.

FIG. 3 is a longitudinal sectional view of a second exemplary embodiment of a reactor in accordance with the invention.

FIG. 3A is a view showing the change in the oxidizing capacity C obtained inside the reactor as a function of the longitudinal path L of the effluents.

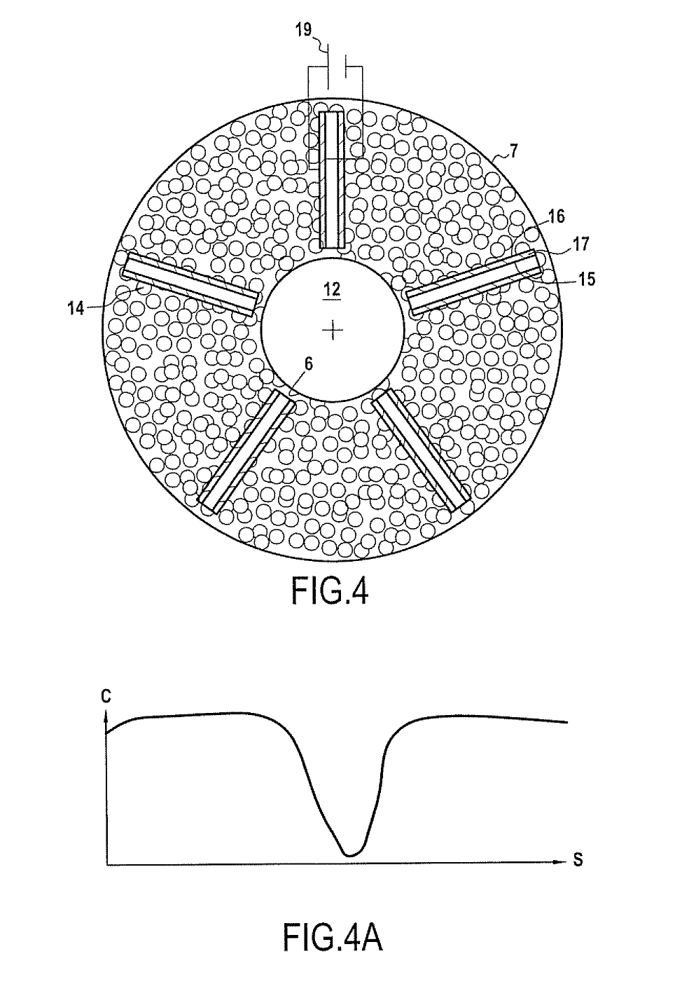

FIG. 4 is a transverse sectional view taken substantially along the lines IV-IV of FIG. 3.

FIG. 4A is a view showing the change in the oxidizing capacity C obtained inside the reactor along a cross section S of the reactor.

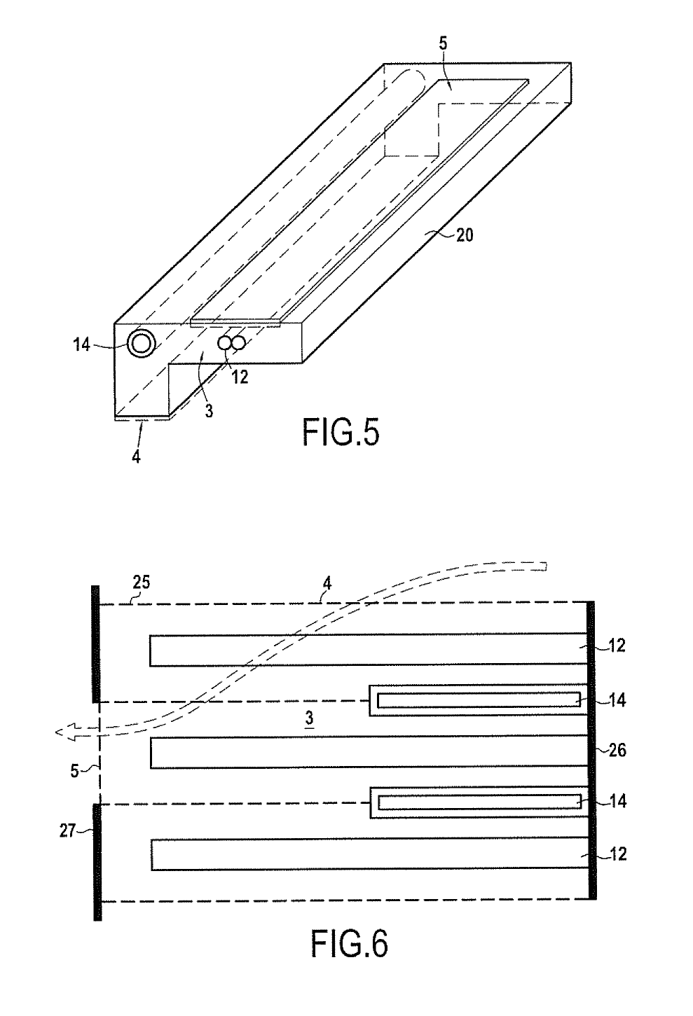

FIGS. 5 to 9 show various other embodiments of reactors in accordance with the invention.

FIGS. 1 and 2 show a first exemplary embodiment of a reactor 1 in accordance with the invention for treating effluents 2 in the general sense. The effluents 2 are gaseous or aqueous in nature, comprising pollutants such as, for example, particles, microorganisms of the virus, bacteria, mold, and algae types, and chemical pollutants of the VOC, SVOC, BTEX, HAP (C10-C25), HAAA, NOₓ, SOₓ, H₂S, CO, and O₃ types, halogenated compounds, endocrine disruptors, and all olfactive molecules.

The reactor 1 comprises a body or vessel 3 having an inlet 4 for the effluents and an outlet 5 for the treated effluents. The vessel 3 internally defines a chamber 6 forming a circuit for moving the effluents between the inlet 4 and the outlet 5, caused to move in a discontinuous or continuous manner.

In the embodiment shown, the vessel 3 comprises an outer wall 7 with a circular section inside which an inner wall 8, also with a circular section, is mounted. The two walls, the inner wall 8 and the outer wall 7, are in the form of two tubular walls mounted in a mutually concentric manner. Thus, the chamber 6 is annular in shape. Clearly, the shape of the reactor may differ from a tubular structure with a circular section.

According to a characteristic of the invention, a bed of porous microbeads 9 is installed inside the vessel 3. As is explained in the remainder of the description, the porous microbeads 9 are placed in the movement circuit 6 so that the effluents pass through the bed of porous microbeads as they advance between the inlet 4 and the outlet 5 of the reactor. In this embodiment, the vessel 3 comprises two transverse walls that are permeable to effluents and that can hold the porous microbeads 9 in position. Thus, for example, the vessel comprises screens 10 as a system for retaining the microbeads 9.

In a variation, it should be noted that the bed of porous microbeads may be fluidized. In this variation, the reactor 1 includes a system 11 for fluidizing the bed of porous microbeads. As an example, the system 11 for fluidizing the bed of porous microbeads 9 can be used to over-pressurize or under-pressurize the bed of porous microbeads. As an example, the system 11 may be a pump or a fan.

The pore size of the porous microbeads is advantageously in the range 3 Å to 10000 Å, advantageously in the range 3 Å to 5000 Å, more preferably in the range 3 Å to 10 Å.

As an example, each porous microbead 9 is spherical in shape and has a diameter in the range 500 μm to 5 cm, preferably in the range 1000 μm to 8000 μm.

The porous microbeads are formed from ilmenite, zeolite, activated coal, and/or potassium permanganate.

According to another characteristic of the invention, the porous microbeads 9 carry a UV-photocatalytic agent.

The photocatalytic agent of the porous microbeads 9 is taken from the following list, alone or in combination: ilmenite, TiO₂, ZnO, MO, and heavy metals.

It should be understood that the porous microbeads 9 are produced from one or more materials. The porous microbeads 9 may be produced from a single material providing it is a photocatalytic agent. Hence, for example, the porous microbeads 9 may be produced solely from ilmenite.

In a variation, all of the porous microbeads 9 of the bed placed inside the reactor 1 are identical. In another variation, the reactor 1 may contain porous microbeads 9 that differ as regards the quantity of their constituent materials and their porosities and their diameters. The porous microbeads 9 may thus have homogeneous or heterogeneous pore sizes, preferably of 3 Å to 10 Å. The porous microbeads 9 may also have homogeneous or heterogeneous diameters of 500 μm to 5 cm. According to another characteristic of the invention, the reactor 1 comprises at least one, and in the example shown in FIGS. 1 to 4 only one, source of UV irradiation 12 for the porous microbeads 9. In the example shown, the source of UV irradiation 12 is mounted in a housing provided inside the inner tubular wall 8. The source of UV irradiation 12 is mounted such that the emitted UV can act on the photocatalytic agents of the porous microbeads 9 installed in the vessel 3. The source of UV irradiation emits at a wavelength in the range 150 nm to 420 nm, preferably in the range 180 nm to 365 nm. Clearly, in the case of a vessel 3 of larger size or a different shape, the reactor 1 may be equipped with a plurality of sources of UV irradiation 12 in order to be able to irradiate all of the porous microbeads 9 placed inside the vessel 3.

The reactor 1 also comprises at least one, and in the example shown in FIGS. 1 and 2, four dielectric barrier discharge devices 14 generating a cold plasma, integrated in a localized manner into the interior of the bed of porous microbeads 9. Each dielectric barrier discharge device 14 comprises two electrodes 15, 16 separated by a dielectric 17. The electrodes 15, 16 are connected to a 12 volt (V) to 220 V direct current (DC) or alternating current (AC) power source 19. It should be noted that each dielectric barrier discharge device 14 is immersed in the bed of porous microbeads 9 such that each dielectric barrier discharge device 14 is surrounded by porous microbeads 9. It should be noted that the porous microbeads 9 cannot be positioned between the electrodes 15, 16, but are located externally of the electrodes 15, 16.

In the example shown in FIGS. 1 and 2, the dielectric barrier discharge devices 14 are disposed axially and are angularly distributed in the vessel 3. Each dielectric barrier discharge device 14 is offset by 90° relative to the neighboring device, extending over a limited length that is less than the axial length of the reactor. As can be seen in FIGS. 1 and 2, each dielectric barrier discharge device 14 thus extends at a distance from the inner 8 and outer 7 walls, and at a distance from the ends of the reactor 1 so as to be able to be completely integrated into or surrounded by the porous microbeads 9.

The reactor 1 described above in accordance with the invention can be used to carry out a particularly effective treatment process.

In fact, the process of the invention is intended to treat effluents with a cold plasma treatment (via the dielectric barrier discharge device or devices 14) simultaneously with the action of a UV-photocatalytic agent (via the source of UV irradiation 12 acting on the porous microbeads 9) to allow the optimized generation of active oxidizing species advantageously primarily composed of radicals forming a radical cloud promoting the treatment and optimized mineralization of the effluents, and consists in carrying out the cold plasma treatment in integrated and localized manner inside the bed of porous microbeads 9 placed inside the reactor 1 and carrying a photocatalytic agent, such that the porous microbeads 9 are not subjected to an electrical discharge via the dielectric barrier of the dielectric barrier discharge devices 14. A process of this type can be used to generate active or oxidizing species of different natures, mainly ions and ozone for the plasma and hydroxide radicals or oxygen radicals for the photocatalysis. These active or oxidizing compounds or species that are generated separately but simultaneously by the cold plasma and by the autocatalytic porous microbeads 9 irradiated by the UV source 12 can destroy and mineralize chemical compounds and microorganisms as well as retain particles and regenerate the porous microbeads 9. Such a principle means that lifetimes and various reaction kinetics in the reactor 1 can be managed appropriately while generating the active or oxidizing species. Depending on the natures of the oxidizing species or reactive species (ions or radicals) (and/or the mixture of reactive species composing the oxidizing capacity of the reactor) and depending on the natures of the pollutants, lifetimes and reaction kinetics are in the range 10⁻⁹ seconds (s) to several seconds.

Thus, the process of the invention means that the quantity of oxidizing species produced inside the bed changes between the inlet 4 and the outlet 5 of the reactor 1, thereby ensuring that oxidizing species are generated locally, as well as being diffused inside the bed. Obtaining an oxidizing species production gradient of this type in the vessel 3 thus allows the simultaneous degradation of a complex mixture of chemical pollutants, microorganic contaminants, and particles, resulting in them being mineralized to CO₂, H₂O, N₂, O₂, and H₂O₂. As can be seen in FIG. 1A, the quantity of oxidizing species produced inside the bed of porous microbeads or the oxidizing capacity C of the reactor progresses or increases between the inlet 4 and the outlet 5 of the reactor.

The reactor 1 of the invention can thus be used to promote the formation of radical species and H₂O₂ by the Fenton effect. H₂O₂ formation can be used to increase the oxidizing capacity C inside the reactor and to increase the total germicidal effect obtained. The remaining H₂O₂ is locally consumed while attacking germs and/or forming OH. It should be understood that the process of the invention thus aims to carry out at least one treatment cycle on the effluents in succession between the inlet and outlet of the reactor, the treatment cycle comprising:
a photocatalytic treatment and partial absorption by the porous microbeads 9 in the zone located between the inlet 4 and the dielectric barrier discharge devices 14;
a photocatalytic treatment combined with a cold plasma treatment and partial absorption by the porous microbeads 9 in the reactor chamber 1 in which the dielectric barrier discharge devices 14 are placed; and
a photocatalytic treatment and partial absorption by the porous microbeads 9 in the zone located between the outlet 5 of the reactor and the dielectric barrier discharge devices 14.

FIGS. 3 and 4 show another exemplary embodiment of a reactor 1 in accordance with the invention, in which the reactor 1 comprises dielectric barrier discharge devices 14 distributed radially in the vessel. In this example, the dielectric barrier discharge devices 14 are radially distributed in a plurality of flow cross sections of the vessel 3. Each flow cross section of the vessel 3 comprises five dielectric barrier discharge devices 14 extending radially from the inner wall 6 of the reactor 1. In the example shown in FIGS. 3 and 4, the reactor 1 comprises three series of dielectric barrier discharge devices 14 distributed between the inlet 4 and the outlet 5 of the reactor 1. The principle of operation of reactor 1 shown in FIGS. 3 and 4 is analogous to the principle of operation of reactor 1 shown in FIGS. 1 and 2. Thus, the quantity of oxidizing species produced inside the bed of porous microbeads or the oxidizing capacity C of the reactor progresses or increases between the inlet 4 and the outlet 5 of the reactor 1 (FIG. 3A). However, the quantity of oxidizing species produced drops or reduces slightly between two neighboring series of dielectric barrier discharge devices 14. Positioning the dielectric barrier discharge devices 14 in series along the path of the effluents means that the overall oxidizing capacity of the reactor can be increased between the inlet and outlet of the reactor, as can be clearly seen in FIG. 3A.

Clearly, the reactor 1 may be provided with radially extending dielectric barrier discharge devices 14 in a single section. Similarly, dielectric barrier discharge devices 14 extending either axially or radially may be combined in the same reactor 1.

FIG. 5 shows a further exemplary embodiment of a reactor in accordance with the invention in the form of an elongate box 20 the interior of which defines the vessel 3. The box 20 has the inlet 4 for the effluents on one of its principal faces and the outlet 5 for the effluents on its principal opposite face. The inlet 4 and outlet 5 extend over all or a portion of the length of the elongated box 20, and are offset laterally relative to each other in order to allow the effluents to move inside the porous microbeads 9 installed inside the vessel 3 and inside which one or more sources of UV irradiation 12 are mounted, which extend longitudinally inside the box 20, along with one or more dielectric barrier discharge devices 14 also extending longitudinally inside the box 20. As an example, the source of UV irradiation 12 is disposed facing the outlet 5, while the dielectric barrier discharge device 14 is located facing the inlet 4.

FIG. 6 shows another variation of a reactor 1, in which the vessel 3 is defined by an outer peripheral wall 25 defining the inlet for the effluents to be treated. This peripheral wall 25 is connected to two transverse walls 26, 27 one of which, for example the wall 27, defines the outlet 5 for the effluents. The vessel 3 comprises one or more sources of UV irradiation 12 extending axially inside the vessel 3 from the wall 26 opposite to that provided with the outlet 5. The reactor also comprises one or more discharge devices 14 extending axially from the wall 26, or also from the wall 25 provided with the outlet 5. The effluents thus enter the vessel 3 tangentially and they leave axially via the outlet 5.

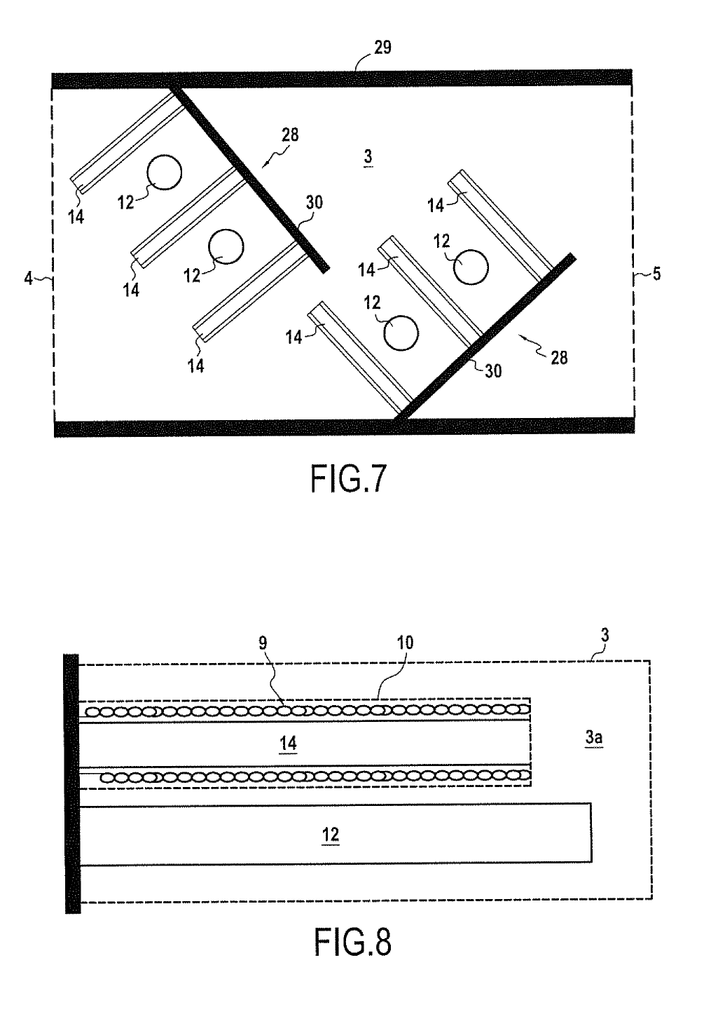

FIG. 7 shows another embodiment of the reactor 1 comprising a series of treatment modules 28 in a staggered arrangement inside the vessel 3 defined by a box 29. Each treatment module 28 comprises a support 30 provided with one or more sources of UV irradiation 12 and one or more discharge devices 14. The treatment modules 28 are placed in succession on the path of the effluents between the inlet 4 and the outlet 5 arranged in two opposed transverse walls of the box 19. Thus, each support 30 extends over the whole width of the box with the sources of UV irradiation 12 that extend along the width of the box, while the dielectric barrier discharge devices 14 rise up from the support 30 because they are distributed on this support 30 in an appropriate manner.

An arrangement of this type of the treatment modules 28 inside the vessel 3 means that a turbulent flow can be created and the flows and pressure drops can be controlled. Advantageously, each support 29 is mounted so as to be capable of being steered freely inside the reactor 1.

Clearly, the vessel 3 of the reactors shown in FIGS. 5 to 7 contains porous microbeads 9 as explained in relation to FIGS. 1 to 4. Such porous microbeads 9 are held in position inside the vessel with the aid of a retaining system 10 that is permeable to the effluents, such as a retaining screen.

It should be noted that the whole of the vessel 3 may be filled with porous microbeads 9. However, it is possible for the porous microbeads 9 to be confined by a retaining system 10 adapted to surround only each dielectric barrier discharge device 14. Thus, as can clearly be seen in FIG. 8, a portion 3a of the vessel 3 does not contain porous microbeads 9. Clearly, such an arrangement may be selected for all of the embodiments of the reactor in accordance with the invention.

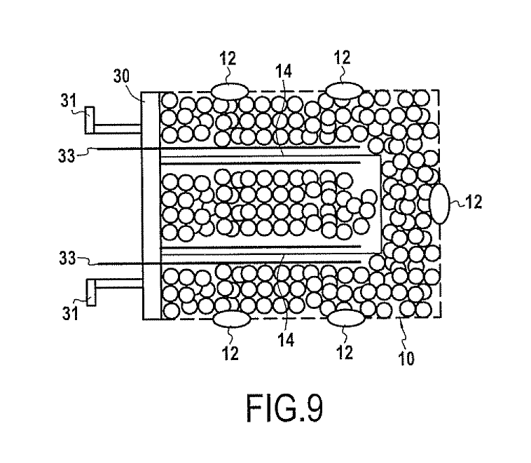

FIG. 9 shows another variation of the reactor 1 in a compact configuration that can preferably be dismantled. The reactor 1 is produced in the form of a detachable cartridge comprising a mounting base 30 provided with temporary fastener means 31 of any type, such as a bayonet or a screw fastening. The base 30 also includes electrical connection terminals 33 for the discharge device 14 and the source of UV irradiation 12. Advantageously, the discharge device 14 is mounted on the base 30 and is surrounded by the porous microbeads 9 retained on the base 30 with the aid of a retaining screen 10 that is permeable to the effluents to be treated. In a preferred but not exclusive variation, the source of UV irradiation 12 is formed by a series of UV light emitting diodes (LEDs) distributed at the periphery of the retaining screen 10.

Clearly, any variation of the reactor of the invention that does or does not comprise a system 11 for fluidizing the bed of porous microbeads 9 is allowable.

The invention is not limited to the examples described and represented, because various modifications may be provided without departing from its scope.

1. A process for treating effluents (2) moving between the inlet (4) and outlet (5) of a reactor (1), consisting in treating the effluents by means of a cold plasma treatment and by means of the action of a UV-photocatalytic agent in order to produce oxidizing species for treating the effluents, characterized in that it consists in treating the effluents with a cold plasma treatment simultaneously with the action of a UV-photocatalytic agent, the cold plasma treatment being carried out in a manner that is integrated into and located within a bed of porous microbeads (9) placed inside the reactor (1) and carrying the photocatalytic agent in order to generate oxidizing species as well as to diffuse them within the bed.

2. The treatment process according to claim 1, characterized in that it consists in producing a fluidized bed of porous microbeads (9) within the reactor (1).

3. The treatment process according to claim 1, characterized in that it consists in carrying out at least one cycle of treatment on the effluents in succession between the inlet (4) and outlet (5) of the reactor (1), the treatment cycle comprising a photocatalytic treatment and partial absorption by the porous microbeads (9), a photocatalytic treatment combined with a cold plasma treatment and partial absorption by the porous microbeads (9), and a photocatalytic treatment and partial absorption by the porous microbeads (9).

4. A reactor for carrying out the treatment process according to claim 1, in that it comprises:
a vessel (3) defining a circuit (6) for moving the effluents (2) between an inlet (4) and an outlet (5) and within which a bed of porous microbeads (9) carrying a UV-photocatalytic agent is installed;
at least one source of UV irradiation (12) for the porous microbeads (9); and
at least one dielectric barrier discharge device (14) generating cold plasma, integrated into the bed of porous microbeads in a localized manner in order to carry out the simultaneous UV irradiation so as to generate oxidizing species as well as diffuse them within the bed.

5. The reactor according to claim 4, characterized in that the vessel (3) is defined by mutually concentric outer and inner walls, a source of UV irradiation (12) being mounted in the housing defined by the inner wall (8), while a series of dielectric barrier discharge devices (14) are integrated into the interior of the vessel (3), the vessel (3) having transverse walls respectively defining the inlet (4) and the outlet (5).

6. The reactor according to claim 5, characterized in that the dielectric barrier discharge devices (14) are disposed either axially, being distributed angularly in the vessel (3), or radially from the inner wall (8) in one or more cross sections of flow of the vessel (3).

7. The reactor according to claim 5, characterized in that the vessel (3) is defined by an elongate box (20) having the inlet (4) for the effluents on one of its faces and the outlet (5) for the effluents on the opposite face, which outlet is offset laterally relative to the inlet, the box containing the bed of porous microbeads (9) in which the dielectric barrier discharge device (14) and the source of UV irradiation (12) are accommodated.

8. The reactor according to claim 5, characterized in that the vessel (3) is defined by an outer peripheral wall defining the inlet and connected to two transverse walls, one of which defines the outlet (5).

9. The reactor according to claim 5, characterized in that the vessel (3) comprises a series of treatment modules in a staggered arrangement inside the vessel, each comprising a steerable support (29) supporting the sources of UV irradiation (12) and the dielectric barrier discharge devices (14).

10. The reactor according to claim 5, characterized in that the vessel (3) is produced in the form of a cartridge that can be detached, comprising a mounting base (30) provided with temporary fastener means (31) and electrical connection terminals (33) for the dielectric barrier discharge device (14) and the source of UV irradiation (12), the bed of porous microbeads (9) being retained on the base with the aid of a retaining screen (10) that is permeable to the effluents to be treated.

11. The reactor according to claim 4, characterized in that it comprises a system (11) for fluidizing the bed of porous microbeads (9).

12. The reactor according to claim 11, characterized in that the system (11) for fluidizing the bed of porous microbeads (9) allows for over-pressurization or under-pressurization of the bed of porous microbeads.

13. The reactor according to claim 4, characterized in that the porous microbeads (9) have pore sizes in the range 3 Å to 10 Å.

14. The reactor according to claim 4, characterized in that the porous microbeads (9) have a diameter in the range 500 μm to 5 cm, preferably in the range 1000 μm to 8000 μm.

15. The reactor according to claim 4, characterized in that the porous microbeads (9) are formed from ilmenite, zeolite, activated coal, and/or potassium permanganate.

16. The reactor according to claim 4, characterized in that the photocatalytic agent of the porous microbeads (9) is taken from the following list, alone or in combination: ilmenite, TiO₂, ZnO, MO, and heavy metals.

17. The reactor according to claim 4, characterized in that the source of UV irradiation (12) emits at a wavelength in the range 150 nm to 420 nm.

18. The reactor according to claim 17, characterized in that the source of UV irradiation (12) is formed by a series of UV diodes distributed at the periphery of the retaining screen (35).
